(19) United States
(12) Patent Application Publication
(10) Pub. No.: US 2008/0112455 A1
(43) Pub. Date: May 15, 2008

(54) System and method for packaging optical elements between substrates

(75) Inventor: Bradley M. Haskett, Allen, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED

(21) Appl. No.: 11/599,937

(22) Filed: Nov. 14, 2006

(51) Int. Cl. H01S 3/08

(52) U.S. Cl. 372/107

(57) ABSTRACT

A laser module includes a first substrate, a second substrate, an optical element, a frequency converter, a selective reflector and a surface-emitter. The first and second substrates are positioned substantially parallel to each other and each include one or more alignment elements. The optical element, the frequency converter, the selective reflector, and the surface-emitter are positioned between the first substrate and the second substrate such that at least a portion of light emission from the surface-emitter travels through the optical element, through the frequency converter, and through the selective reflector. Each of the optical element, the frequency converter, the selective reflector, and the surface-emitter are at least partially supported by the one or more alignment elements.

### TECHNICAL FIELD

This invention relates in general to packing optical elements and, in particular, to a system and method for aligning and packaging optical elements of a laser module.

### BACKGROUND

Within the optics industry, numerous applications require a light source capable of producing visible light of significant power levels. For example, DLP® high definition televisions (HDTV) incorporate high-power lamps or light-emitting diodes (LED). More recently, vertical external cavity surface-emitting lasers (VECSELS) have been developed that, when combined with a frequency-doubling crystal, form a laser module capable of producing sufficient visible light to power video displays. Conventional packaging of the optical components that make up the laser module is expensive and difficult to manufacture for a variety of reasons.

### SUMMARY OF THE EXAMPLE EMBODIMENTS

In one embodiment, an apparatus for use with a laser module includes a first substrate and a second substrate positioned substantially parallel to each other. Each substrate includes one or more alignment elements. In addition, the apparatus includes an optical element, a frequency converter, a selective reflector, and a surface-emitter positioned between the first substrate and the second substrate such that at least a portion of light emission from the surface-emitter travels through the optical element, through the frequency converter, and through the selective reflector. Each of the optical element, the frequency converter, the selective reflector, and the surface-emitter are at least partially supported by the one or more alignment elements.

In a method embodiment, a method for converting light generated by a surface-emitter includes coupling each of a surface-emitter, an optical element, a frequency converter, and a selective reflector to a first substrate and a second substrate. In addition, the method includes directing a light emission from the surface-emitter through the optical element and through the frequency converter to the selective reflector.

Technical advantages of some embodiments of the invention may include the capability of passively aligning and coupling the various components of a laser module within tight tolerances, without reference to optical output. In addition, various embodiments may enhance temperature management within the laser module.

It will be understood that the various embodiments of the present invention may include some, all, or none of the enumerated technical advantages. In addition, other technical advantages of the present invention may be readily apparent to one skilled in the art from the figures, description, and claims included herein.

### BRIEF DESCRIPTION OF THE DRAWINGS

For a more complete understanding of the present invention and features and advantages thereof, reference is now made to the following description, taken in conjunction with the accompanying drawings, in which:

FIG. 1 is a cross-sectional block diagram of one embodiment of a portion of a light processing system;

FIG. 2 is a perspective view illustrating one embodiment of a portion of a laser module of the light processing system of FIG. 1;

FIG. 3 is a cross-sectional view illustrating one embodiment of the components and optical path for a portion of a laser module of the light processing system of FIG. 1;

FIG. 4 is a cross-sectional view illustrating one embodiment of a portion of a laser module of the light processing system of FIG. 1, after the formation of one or more alignment elements on a surface of a substrate; and

FIG. 5 is a perspective view illustrating one embodiment of a portion of a laser module of the light processing system of FIG. 1.

### DESCRIPTION OF EXAMPLE EMBODIMENTS

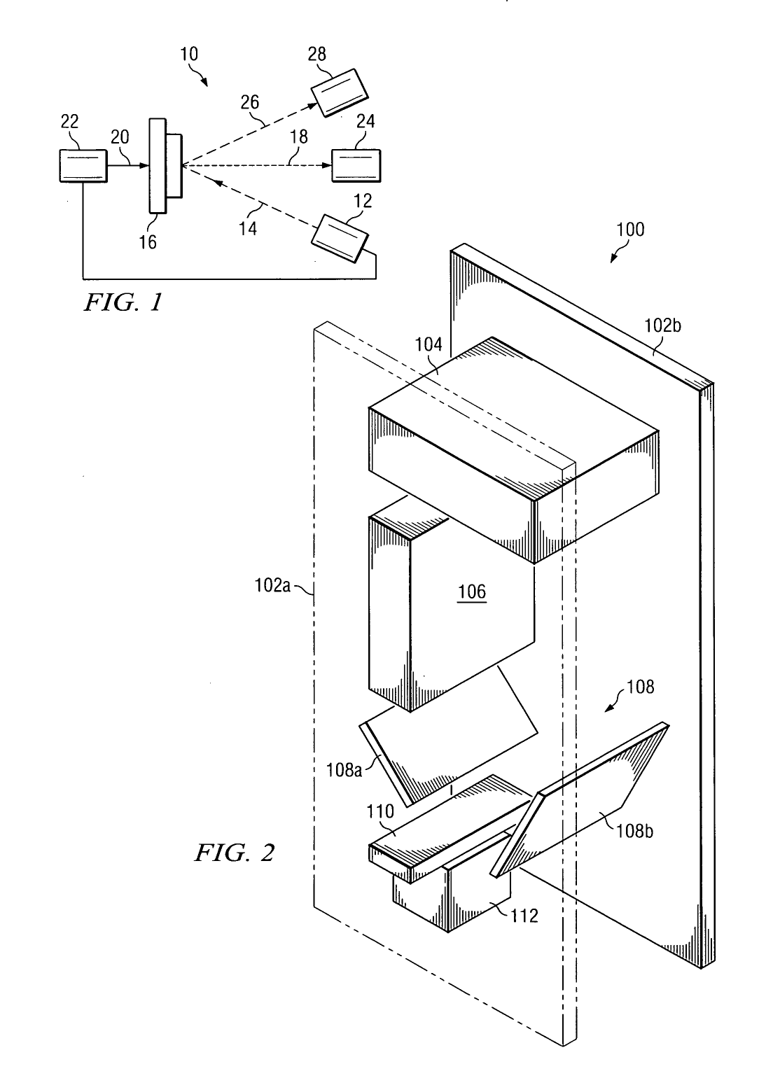

Embodiments of the present invention and its advantages are best understood by referring to FIGS. 1 through 4 of the drawings, like numerals being used for like and corresponding parts of the various drawings.

FIG. 1 is a cross-sectional block diagram of one embodiment of a portion of a light processing system 10 according to the teachings of the invention. The display system 10 of FIG. 1 generally includes a light source module 12, a modulator 16, a light absorber 28, a projection lens 24, and control circuitry 22.

Light source module 12 is capable of generating illumination light beams 14 sufficient to produce a visible display. In this particular embodiment, light source module 12 comprises a laser module, as explained further below. Light beams 14 are directed from laser module 12 to a modulator 16. Modulator 16 may comprise any device capable of selectively communicating at least some of the received light beams along a projection light path 18. In various embodiments, modulator 16 may comprise a spatial light modulator, such as, for example, a liquid crystal display, an interferometric modulator, or a liquid crystal on silicon display. In the illustrated embodiment, however, modulator 16 comprises a digital micromirror device (DMDTM), sometimes known as a deformable micromirror device. Of course, modulators other than DMDs 16 depicted and described in detail herein may advantageously utilize the principles of the present disclosure.

A DMD is a microelectromechanical systems (MEMS) device comprising an array of hundreds of thousands of deformable micromirrors. In the illustrated embodiment, deformation of each micromirror between “on” and “off” positions is effected by the attractive or repulsive electrostatic forces exerted thereon by electric fields. The electric fields result from the application of appropriate potentials 20 as applied by control circuitry 22.

In the illustrated embodiment, incident illumination light on the micromirror array is reflected by the “on” micromirrors along projection path 18 for receipt by projection lens 24. Additionally, illumination light beams 14 are reflected by the “off” micromirrors and directed on off-state light path 26 toward light absorber 28. The pattern of “on” versus “off” mirrors (e.g., light and dark mirrors) forms an image that is projected by projection lens 24.

A better understanding of various aspects of the present invention may be had by making reference to FIGS. 2 through 4, which illustrate various portions of light source module 12 in accordance with particular embodiments of the present invention.

FIG. 2 is a perspective view of one embodiment of a portion of a laser module. In this particular embodiment, laser module 100 is capable of producing sufficient visible light for display applications such as, for example, the light processing system 10 of FIG. 1.

In the illustrated embodiment, laser module 100 comprises a system of components 104, 106, 108, 110 and 112 positioned between at least two substrates 102a and 102b. The components generally include a surface-emitter 110 coupled to a heat sink 112, one or more optical elements 108, a frequency converter 106, and a selective reflector 104. Each component 104, 106, 108, 110 and 112 is coupled to at least one of the substrates 102a and 102b. Although a laser module 100 is depicted and described in detail herein, the teachings of the present disclosure are applicable to the alignment and packaging of any module including one or more optical elements.

Substrates 102a and 102b may comprise any suitable material for housing laser module 100 components. For example, substrates 102 may comprise multi-layer co-fired ceramic headers. In this particular example, however, substrates 102a and 102b both comprise silicon optical benches (SiOB). In addition, substrate 102a is substantially parallel to substrate 102b.

Surface-emitter 110 may comprise, for example, a plurality of vertical-cavity surface-emitters that produce diffraction-limited Gaussian beams of infrared (IR) light; however, any suitable device that emits light may be used. In this particular embodiment, at least a portion of surface-emitter 110 is coupled to a heat sink 112.

Heat sink 112 may comprise any material capable of at least partially dissipating the heat generated by surface-emitter 110. For example, heat sink 112 may comprise a highly conductive metal such as copper-tungsten or a thermally conductive ceramic such as aluminum-nitride. In this particular embodiment, heat sink 112 is not directly connected to substrates 102, thus improving the thermal isolation of surface-emitter 110.

Optical element 108 may comprise, for example, any suitable material capable of reflecting, polarizing, and/or beam-splitting light. In this embodiment, optical element 108 comprises two dichroic mirrors 108a and 108b, each positioned plus or minus approximately forty-five degrees relative to the surface of surface emitter 110. Depending on the desired optical output from laser module 100, other embodiments may not include dichroic mirrors 108a and/or 108b. Although this example uses dichroic mirrors 108a and 108b, other selectively reflective elements may be used without departing from the scope of the present disclosure. For example, other embodiments may use one or more total internal reflection (TIR) prisms.

Frequency converter 106 typically comprises crystals capable of harmonic generation such as, for example, periodically poled lithium niobate (PPLN) crystals or Lithium Triborate LiB3O5 (LBO) crystals.

In the illustrated embodiment, selective reflector 104 is substantially parallel to surface-emitter 110. Selective reflector 104 typically comprises one or more selective mirrors, each mirror transmitting specific frequencies of visible light while reflecting other frequencies, such as IR for example.

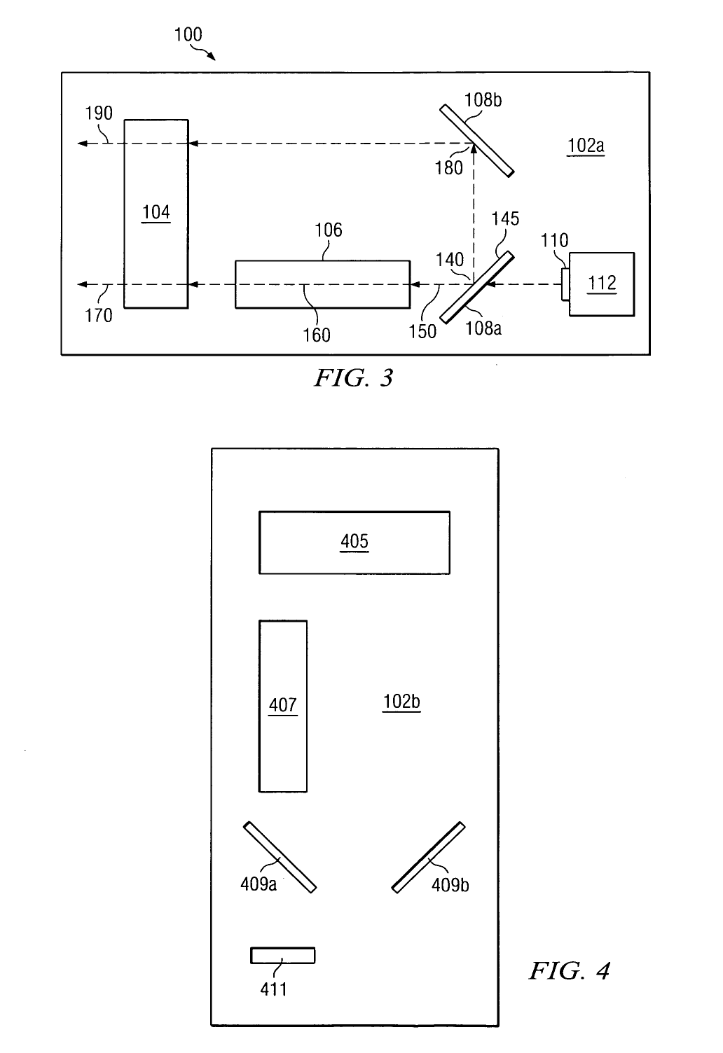

As described further below with reference to FIG. 3, the components 104, 106, 108, and 110 of laser module 100, in this example embodiment, are aligned in their relative positions to direct and convert IR light beams emitted from surface emitter 110 into polarized, visible light.

Conventional packaging of the optical components that make up visible laser modules is expensive and difficult to manufacture for a variety of reasons. Some of the typical optical components do not have practical mounting surfaces that are on a common plane. This complicates aligning the components within tight tolerance requirements. In addition, conventional laser module packaging generally involves active alignment, wherein components such as the selective reflector are aligned to the remainder of the laser module based on the laser module optical output. Such active alignment is tedious, expensive, and often includes the use of a six-axis stage to adjust the component alignment, prior to locking it in place by adhesive. Heat management is another difficulty associated with conventional laser module packaging. The laser emitter generates a significant amount of heat that must be efficiently removed from the module, while the frequency-doubling crystal is maintained at a very specific temperature and therefore thermally isolated from the laser emitter.

Unlike conventional laser modules described in the background, surface-emitter 110, optical element 108, frequency converter 106, and selective reflector 104 are positioned between two substantially parallel substrates 102a and 102b. As will be shown, this configuration greatly facilitates the alignment and coupling of each component 104, 106, 108a, 108b, 110 to substrates 102 within tight tolerances. For example, in various embodiments, each component may be passively aligned without reference to optical output. In addition, this configuration provides minimal contact between surface-emitter 110 and substrates 102, and no direct contact between heat sink 112 and substrates 102, thereby efficiently and inexpensively managing temperature control within laser module 100.

FIG. 3 is a cross-sectional view illustrating one embodiment of the components 104, 106, 108a, 108b, 110, and 112 and optical paths for a portion of the laser module 100 of FIG. 2. In various embodiments, laser module 100 may be used as the light source module 12 of FIG. 1.

In the illustrated embodiment, the IR output from surface-emitter 110 is polarized as it passes through dichroic mirror 108a in a direction substantially parallel to the surface of substrates 102, as indicated by reference number 140. The IR output from optical element 108a passes through frequency converter 106, which converts at least a portion of the IR beam into visible light.

In the illustrated embodiment, selective reflector 104 is capable of transmitting specific frequencies of visible light converted within frequency converter 106, while reflecting other frequencies of light. Laser module 100 outputs the visible light transmitted through selective reflector 104, as indicated by reference number 170.

In the illustrated embodiment, light reflected from selective reflector 104 returns back through frequency converter 106. As the IR reflected from selective reflector 104 returns through frequency converter 106, as indicated by reference number 160, at least a portion of the IR beam converts to visible light.

In the illustrated embodiment, a beam-splitting surface within optical element 108a, indicated by reference number 145, reflects a range of visible light 90 degrees, as indicated by reference numeral 140, while transmitting other frequencies, including IR. The reflected visible light folds 90 degrees, as indicated by reference number 180, by a surface of optical element 108b, and outputs from laser module 100 in a direction parallel to the light transmitted through selective reflector 104, as indicated by reference number 190. The transmitted IR reflects off surface-emitter 110 and combines with the output from surface-emitter 110.

Other embodiments that require only a single output from laser module 100 may not necessarily reflect light within optical element 108. Such embodiments may comprise, for example, an optical element 108 that performs the function of polarizing light without reflecting or redirecting light.

FIG. 4 is a cross-sectional view illustrating one embodiment of a portion of the laser module 100 of FIG. 2, after the formation of one or more alignment elements 405, 407, 409a, 409b, and 411 on a surface of substrate 102b. Alignment elements 405, 407, 409a, 409b, and 411 are capable of facilitating aligning and/or coupling one or more components (e.g., components 104, 106, 108a, 108b, 110) to substrates 102a and/or 102b. In this particular embodiment, alignment elements 405, 407, 409, and 411 correspond respectively to selective reflector 104, frequency converter 106, optical elements 108, and surface-emitter 110.

In various embodiments, substrates 102a and 102b may not necessarily include corresponding or matching alignment elements. For example, in various other embodiments, frequency converter 106 may be coupled only to one or more alignment elements on substrate 102a, without coupling to a corresponding alignment element on substrate 102b. However, in this particular embodiment, each alignment element 405, 407, 409a, 409b, and 411 of substrate 102b has a corresponding alignment element (not explicitly shown) on substrate 102a, thereby potentially enhancing structural rigidity and alignment tolerances of laser module 100.

Alignment elements 405, 407, 409a, 409b, and 411 may comprise any material suitable for facilitating aligning and/or coupling one or more of the components 104, 106, 108a, 108b, 110 to substrates 102a and/or 102b. In this particular embodiment, alignment elements 405, 407, 409a, 409b, and 411 each comprise a metallization layer formed on a surface of substrates 102. Forming alignment elements 405, 407, 409a, 409b, and 411 may be effected through any of a variety of processes. In this particular embodiment, alignment elements 405, 407, 409a, 409b, and 411 can be formed substantially simultaneously by depositing, patterning, and etching a metallic layer on or within substrates 102 using photolithographic techniques. One advantage of this example embodiment is that photolithographic metallization can efficiently position alignment elements 405, 407, 409a, 409b, and 411 within extremely tight tolerances.

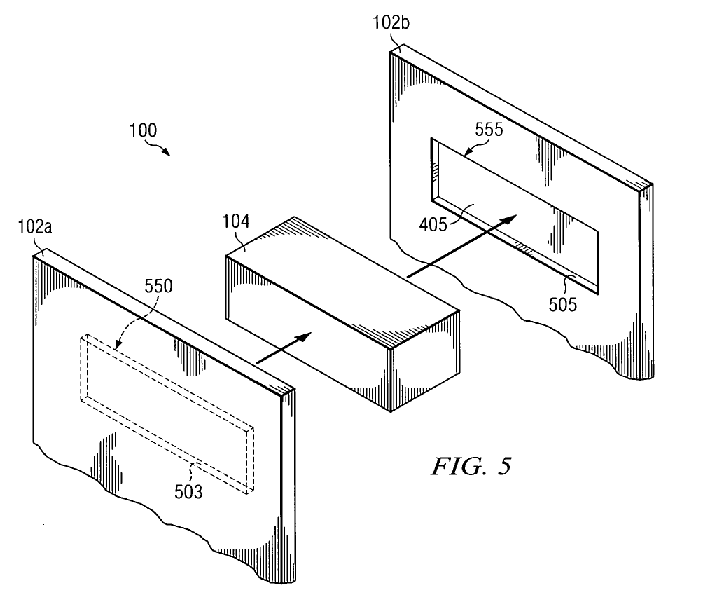

Aligning and coupling components 104, 106, 108a, 108b, 110 to substrates 102a and/or 102b can be effected through any of a variety of processes. In various embodiments, components 104, 106, 108a, 108b, 110 are coupled using solder techniques, wherein each component is passively self-aligned to respective alignment elements (e.g., 405, 407, 409a, 409b, and 411). However, in this particular embodiment, aligning and coupling components 104, 106, 108a, 108b, 110 to substrates 102a and/or 102b is effected through the use of additional alignment elements, as described further in FIG. 5.

FIG. 5 is a perspective view illustrating one embodiment of a portion of the laser module 100 of FIG. 2 after the formation of alignment elements 550 and 555 within substrates 102a and 102b respectively. As previously mentioned, in various embodiments, laser module 100 may be used as the light source module 12 of FIG. 1. In this particular embodiment, alignment elements 550 and 555 include mechanical alignment groves 503 and 505 respectively. In various embodiments, groves 503 and 505 are capable of facilitating aligning and/or coupling one or more components (e.g., selective reflector 104) to substrates 102a and/or 102b. Although this particular embodiment uses multiple groves 503 and 505 to facilitate aligning and coupling components to substrates 102a and 102b, other embodiments may couple and/or align various individual components using one or more mechanical alignment groves on only one of the substrates 102 without departing from the scope of the present disclosure.

In this particular embodiment, alignment elements 550 and 555 also include photolithographically processed metallization layers (e.g., alignment element 405 of FIGS. 4 and 5). In various embodiments, metallization layer 405 can be formed after the formation of grove 505. In this particular embodiment, however, metallization layer 405 is formed on an interior layer of silicon optical bench (SIOB) substrate 102b prior to the formation of grove 505. Although alignment elements 550 and 555 include metallization layers in addition to groves 503 and 505, other embodiments may include only mechanical alignment groves, only metallization layers, or any other appropriate aligning and/or coupling elements on or within substrates 102 without departing from the scope of the present disclosure.

Forming groves 503 and 505 may be effected through any of a variety of processes. In this particular embodiment, groves 503 and 505 are formed by chemically etching a portion of substrates 102a and 102b respectively. One advantage of this particular example embodiment is that the chemical etch may be performed on SiOB substrates 102 using highly precise and efficient semiconductor processing techniques. Such techniques can produce highly accurate sidewalls for groves 503 and 505 that match the dimensions of respective components (e.g., selective reflector 104). In addition, in various embodiments, such techniques can facilitate alignment between groves and corresponding metallization layers (e.g., 505 and 405 respectively).

Aligning and coupling components (e.g., selective reflector 104) to substrates 102a and/or 102b can be effected through any of a variety of processes. For example, in various embodiments each component may be coupled to substrates 102 by a stable adhesive, such as epoxy. In this particular embodiment, however, at least a portion of the components (e.g., selective reflector 104) are mechanically fitted into groves (e.g., 505 and 503) and permanently coupled in place by soldering the components (e.g., selective reflector 104) to metallization layers or pads (e.g., alignment element 405).

In various embodiments, alignment elements may merely assist in aligning and/or coupling components to parallel substrates. For example, in some embodiments, a selective reflector may be actively aligned to the remainder of the laser module based on the optical output from laser module, and then permanently held in place by, for example, solder or a very stable adhesive. In such embodiments, the alignment elements can be designed to allow slight variations in the placement of the component relative to the parallel substrates. In still other embodiments, various components may not use alignment elements to align and/or couple to parallel substrates. For example, actively-aligned components can couple directly to at least one of two parallel substrates after the active alignment process.

Particular examples and dimensions specified throughout this document are intended for example purposes only, and are not intended to limit the scope of the present disclosure. In particular, this document is not intended to be limited to a particular spatial light modulator device, such as, a digital micromirror device. Moreover, the illustrations in FIGS. 1 through 4 are not necessarily drawn to scale.

Although the present invention has been described in several embodiments, a myriad of changes, variations, alterations, transformations, and modifications may be suggested to one skilled in the art, and it is intended that the present invention encompass such changes, variations, alterations, transformations, and modifications as falling within the spirit and scope of the appended claims.

What is claimed is:

1. A light processing system comprising:
a light source capable of transmitting a beam of light;
a spatial light modulator comprising a plurality of pixel elements, each pixel element capable of selectively communicating light received from the light source to produce a visual display;
wherein the light source comprises:
a first substrate and a second substrate positioned substantially parallel to each other and each comprising one or more alignment elements;
an optical element, a frequency converter, a selective reflector, and a surface-emitter each positioned between the first substrate and the second substrate such that at least a portion of light emission from the surface-emitter travels through the optical element, the frequency converter, and the selective reflector; and
wherein each of the optical element, the frequency converter, the selective reflector, and the surface-emitter are at least partially supported by the one or more alignment elements.

2. A laser module comprising:
a first substrate and a second substrate positioned substantially parallel to each other and each comprising one or more alignment elements;
an optical element, a frequency converter, a selective reflector, and a surface-emitter positioned between the first substrate and the second substrate such that at least a portion of light emission from the surface-emitter travels through the optical element, the frequency converter, and the selective reflector; and
wherein each of the optical element, the frequency converter, the selective reflector, and the surface-emitter are at least partially supported by the one or more alignment elements.

3. The laser module of claim 2, wherein the one or more alignment elements comprise metallization.

4. The laser module of claim 3, wherein the metallization comprises photolithographically patterned metal.

5. The laser module of claim 3, wherein at least partially supported by the alignment elements comprises at least partially supported by solder attachment.

6. The laser module of claim 2, wherein the one or more alignment elements comprise mechanical grooves.

7. The laser module of claim 6, wherein the mechanical groves comprise chemically etched wells.

8. The laser module of claim 2, wherein the surface-emitter, the optical element, the frequency converter, and the selective reflector are further positioned such that at least a portion of the light emission from the surface-emitter cycles between surface-emitter and the selective reflector.

9. The laser module of claim 2, wherein the surface-emitter forms a part of a vertical external cavity surface-emitting laser.

10. The laser module of claim 2, wherein the optical element polarizes at least a portion of the light emission from the surface-emitter.

11. The laser module of claim 2, wherein the optical element is capable of beam-splitting the light transmitted from the frequency converter such that light having a first set of frequencies is directed in a first direction and light having a second set of frequencies is directed in a second direction.

12. The laser module of claim 2, and further comprising a heat sink coupled to the surface-emitter, the heat sink not directly coupled to the first substrate and the second substrate.

13. The laser module of claim 2, wherein the optical element comprises one or more mirrors.

14. A method for converting light generated by a surface-emitter comprising:
coupling each of a surface-emitter, an optical element, a frequency converter, and a selective reflector to each of a first substrate and a second substrate; and
directing a light emission from the surface-emitter through the optical element and the frequency converter to the selective reflector.

15. The method of claim 14, wherein coupling each of a surface-emitter, an optical element, a frequency converter, and a selective reflector to a first substrate and a second substrate comprises positioning each of a surface-emitter, an optical element, a frequency converter, and a selective reflector between the first substrate and the second substrate.

16. The method of claim 14, and further comprising providing each of the first and second substrates with one or more alignment elements; and
wherein coupling each of a surface-emitter, an optical element, a frequency converter, and a selective reflector to a first substrate and a second substrate comprises coupling each of a surface-emitter, an optical element, a frequency converter, and a selective reflector to respective alignment elements.

17. The method of claim 16, wherein providing each of the first and second substrates with one or more alignment elements comprises patterning metal using photolithography.

18. The method of claim 17, wherein coupling each of a surface-emitter, an optical element, a frequency converter, and a selective reflector to a first substrate and a second substrate comprises coupling each of the surface-emitter, the optical element, the frequency converter, and the selective reflector to the first substrate and the second substrate using solder attachment.

19. The method of claim 16, wherein providing each of the first and second substrates with one or more alignment elements comprises providing each of the first substrate and the second substrate with mechanical grooves.

20. The method of claim 19, providing each of the first and second substrates with mechanical grooves comprises chemically etching at least a portion of the first substrate and the second substrate.
